(19) United States
(12) Patent Application Publication
(10) Pub. No.: US 2014/0139658 A1
(43) Pub. Date: May 22, 2014

(54) REMOTE VISUAL INSPECTION SYSTEM AND METHOD

(71) Applicant: GENERAL ELECTRIC COMPANY, Schenectady, NY (US)

(72) Inventors: Srivatsa Sampath Dhanvantri, Bangalore (IN); Srinivas Venkatappa, Bangalore (IN); Chittuluri Raveendra Guptha, Bangalore (IN)

(73) Assignee: General Electric Company, Schenectady, NY (US)

(21) Appl. No.: 13/682,213

(22) Filed: Nov. 20, 2012

(51) Int. Cl. H04N 7/18

(52) U.S. Cl. CPC H04N 7/18
USPC 348/85

(57) ABSTRACT

A remote visual inspection system and method for transmitting live digital video of an ongoing inspection to remote network sites is disclosed.

### BACKGROUND OF THE INVENTION

The subject matter disclosed herein relates to a remote visual inspection system and method that transmits live digital video of an ongoing inspection to remote network sites.

Remote visual inspection devices, such as video borescopes, can be used to inspect interior regions of industrial equipment such as airframes, pipes, engines, and other articles. In many instances, these interior regions of the articles are inaccessible and cannot be viewed without the use of the borescope. Borescope instruments are used to visually inspect an article for leaks, cracks, gaps, foreign objects, blockages, corrosion, and other anomalies that may have resulted from damage, wear, or improper installation. Exemplary borescopes include a processing station connected to a narrow insertion tube having an image capture device as an end piece. The end piece typically contains a camera head with a lens, a digital image capture device, a light source, and means for transmitting captured digital images through the insertion tube back to the processing station. The processing station can include standard personal computer (PC) features such as an operating system and file system for storing images and videos captured by the borescope during an inspection session. A hand held display screen connected between the insertion tube and the processing station allows an operator of the borescope to visually inspect interior regions of the article being inspected, to maneuver the camera head end, and to selectively capture digital images viewed through the display screen during inspection.

An inspection of an article can be recorded as videos and still images to be later analyzed by engineering experts. Hardcopy or electronic inspection reports can be annotated with digital images captured during inspection and sent globally to appropriate experts for review and engineering analysis. Typically, the technician who is carrying out the borescope inspection is not qualified to make determinations as to repair, decisions to remove equipment from service, or to recommend other corrective actions. Hence, the inspection reports and images are transmitted to sites where engineering analysis can be undertaken.

The discussion above is merely provided for general background information and is not intended to be used as an aid in determining the scope of the claimed subject matter.

### BRIEF DESCRIPTION OF THE INVENTION

A remote visual inspection system and method for transmitting live digital video of an ongoing inspection to remote network sites is disclosed. An advantage that may be realized in the practice of some disclosed embodiments of the remote visual inspection system and method is live remote viewing of an inspection for immediate expert analysis and recommended corrective action of conditions discovered by the inspection.

In one embodiment, a remote visual inspection system comprises a borescope inspection apparatus having an elongated tube. One end of the tube includes an image capture device and the other end is connected to a processing station. The processing station includes a network connection port for transmitting live digital video captured by the image capture device over a network. A computer terminal with a display receives the live digital video transmission.

In another embodiment, a remote visual inspection system comprises a borescope inspection apparatus having an elongated tube with an image capture device at one end and the other end connected to a processing station. The processing station displays the captured digital images on a display and transmits the captured digital images live over a network. A computer terminal receives the live digital images transmitted over the network.

In another embodiment, a method of remote visual inspection comprises maneuvering an insertion tube of a borescope inspection apparatus into an interior region of an article. The insertion tube is electrically connected to the borescope inspection apparatus. The borescope inspection apparatus is connected to a network and digital images of the interior region of the article are captured using an image capture device in the insertion tube. The captured digital images are forwarded live over the network and are received at a computer terminal having a display screen for displaying the live forwarded captured digital images.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is an exemplary borescope inspection apparatus;

FIG. 2 illustrates an exemplary remote visual inspection system; and

FIG. 3 illustrates a method of operating the remote visual inspection system for efficient corrective action.

### DETAILED DESCRIPTION OF THE INVENTION

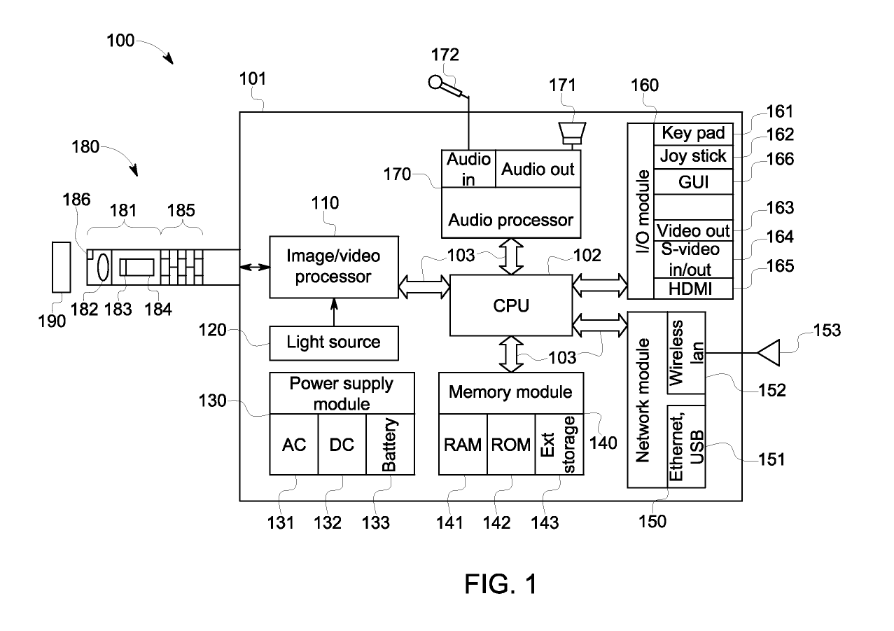

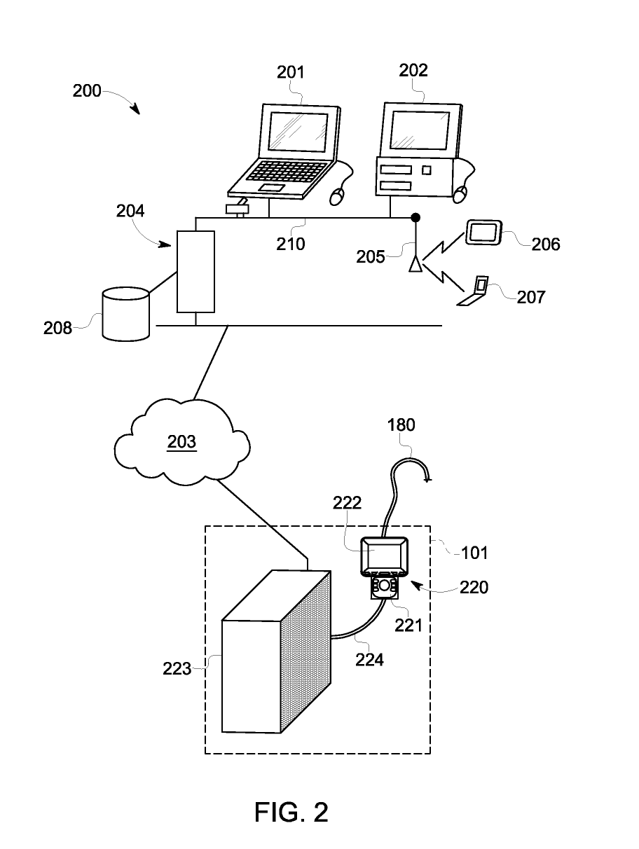

As illustrated in FIGS. 1-2, disclosed herein is a borescope inspection apparatus 100 and a remote visual inspection system 200 for inspecting an article 190 which, in one embodiment, can comprise an industrial equipment article. The remote visual inspection system 200 can comprise one or more computer terminals 201, 202 external to a borescope inspection apparatus 100. The borescope inspection apparatus 100 can comprise, e.g., an elongated insertion tube 180 having video and image capture electronics disposed therein, such as a two dimensional image sensor comprising a charge coupled device (CCD) array or complementary metal-oxide semiconductor (CMOS) based photodiodes. The insertion tube 180 can be attached to a control handle 220 which includes various user interface controls, such as control handle buttons 221 and a control handle display 222, and can include a portion of the borescope processing station 101 electronics comprising a processing system of the borescope inspection apparatus 100. The borescope inspection apparatus 100 can be configured to enable internet protocol (IP) based video and image communications between the borescope inspection apparatus 100 and other computers 201, 202, 204 over a public IP network 203, such as the internet. The borescope inspection apparatus 100 can be configured to include a user interface for enabling a user to initiate an IP based video streaming connection over an IP network 203 with a remote computer 201, 202, 204 of the remote visual inspection system 200. A technical effect of this system is improved inspection information dissemination and analysis during inspection of, for example, an industrial article.

FIG. 1 is a block diagram of an exemplary borescope inspection apparatus 100. It will be understood that the borescope inspection apparatus 100 shown in FIG. 1 is exemplary and that the scope of the invention is not limited to any particular device described herein or any particular configuration of components within an inspection device. As described above, any portion of the electronic components shown in borescope processing station 101 can be disposed in control handle 220 and a remainder of the electronics components disposed in base processing station 223. Together, processing system components in control handle 220 and in base processing station 223 connected by electrical communication cable 224 comprise processing station 101 components as illustrated in FIG. 1.

Borescope inspection apparatus 100 can include an elongated probe comprising an insertion tube 180, whose length may extend from a few feet to tens of feet. Borescope inspection apparatus 100 can comprise a camera head assembly 181 disposed at the distal end of the insertion tube 180. Camera head assembly 181 can include image capture components such as probe optics having a lens 182 for guiding and focusing light from the viewed article 190 onto an imager 183. Imager 183 can comprise a two dimensional CCD array or a CMOS based array of photodiodes. The lens 182 can be, e.g., a lens singlet or a lens having multiple components. The imager 183 can be used for capturing an image of the viewed article 190. Insertion tube 180 includes a bending neck 185 which can be a flexible, tubular section for bending the head assembly at any angle to better view interior regions of article 190 using articulation cables within the insertion tube 180 (not shown). In one embodiment, articulation cables in elongated insertion tube 180 are controllable using joystick 162 to control movement of camera head assembly 181 into a desired position during inspections. The insertion tube 180 contains all necessary mechanical articulation cables for maneuvering the camera head assembly 181 and for electrical wiring to interconnect the camera head assembly 181 and video/image electronics 110 for collecting digital image data. The image/video processor 110 is an example of a processing system component that can be disposed in control handle 220.

The camera head assembly 181 can be detachable and replaceable with other camera head assemblies having different image capture resolution or a different size, as desired. It can also include a connection tip for attaching additional adapters on the distal end of the camera head assembly 181 such as optical filters or aperture control devices that work in conjunction with the lens 182 to guide and focus light from the viewed article 190 onto an imager 183. The detachable camera head assembly 181 can also include an illumination source 186 which can comprise LEDs or optical fibers connected to a light source 120 within the borescope processing station 101. Camera head assembly 181 can also provide the ability for side viewing by including a waveguide (e.g., a prism) to direct the camera view and light output to the side. The light source 120 and the optical fibers or LED control are further examples of processing system components that can be disposed in control handle 220.

The imager 183 can include a plurality of photodiodes formed in a plurality of rows and columns and can generate image signals in the form of voltages representative of light incident on each photodiode of the imager 183. The image signals can be propagated through image buffer 184 to the image/video processing electronics 110. The image/video processing electronics 110 can include an analog/digital converter (ADC) and digital signal processing electronics for processing and formatting image output from imager 183. The image/video processor 110, in the embodiment shown, can be configured to perform processing tasks such as color matrix processing, gamma processing, and can process digital image signals into a standardized video format. Central processing unit (CPU) 102, in turn, can receive image/video data from image/video processor 110 and store video/image data in any of random access memory (RAM) 141, read only memory (ROM) 142, or external memory 143 connected to CPU 102 using borescope processing station bus 103.

The image/video processor 110 is one module of several in the borescope processing station 101, which provide several functions for operating the borescope inspection apparatus 100. These modules can be provided on separately packaged integrated circuits (ICs), or connected on a single or several printed circuit boards. The image/video processor 110 includes memory for storing adjustable gain and exposure settings, for adjusting an amount of light emanating from camera head assembly 181 for illuminating article 190, and for communicating image data with the CPU 102 of the borescope processing station 101.

Image/video processor 110 can receive a video signal from the imager 183 and output these video signals to CPU 102 which, in turn, can controllably send live still image and video data to various monitors connected over I/O module 160 outputs such as video out 163, S-video 164, or HDMI 165. These video formats are exemplary representative formats and can include any known video formats. The control handle display 222 integrally formed in control handle 220 can be connected internally to CPU 102 for displaying digital still or video images transmitted from camera head assembly 181, and can include, for example, an LCD or LED screen integrally built into the borescope inspection apparatus 100 control handle 220 for displaying various images or data (e.g., the image of the viewed article 190, or menus, a cursor, measurement results) to an inspector operating the borescope inspection apparatus 100.

The image/video processor 110 can transmit status information, streaming video, still images, and graphical overlays to CPU 102 and can receive commands from CPU 102. CPU 102 can comprise any of a number of general purpose processors, such as a Pentium® brand processor. Image/video processor may be comprised of field programmable gate arrays (FPGAs), digital signal processors (DSPs), application specific integrated circuits (ASICs), a general purpose processor, or a combination thereof. Image/video processor 110 can provide functions such as image capture, image enhancement, image or graphic overlay and merging such as menus, distortion correction, frame averaging, scaling, digital zooming, overlaying, merging, panning, motion detection, and video format conversion and compression.

The CPU 102 can be used to manage the user interface via I/O module 160 by receiving input from a user via a joystick 162, key pad 161, or user interface 166 which can be a graphical user interface operated from control handle 220 using control handle display 222, or user interface 166 can include control options on base processing station 223. CPU 102 can provide a host of other functions, including image, video, and audio storage and recall functions, system control, and measurement processing. In this respect borescope processing station 101 can include a standard personal computer (PC) operating system and file system. The joystick 162, key pad 161, or GUI 166 can be manipulated by the operator to perform such operations as menu selection, cursor movement, slider adjustment, and articulation control of the insertion tube 180. The joystick 162, key pad 161, or GUI 166 can also can be used for providing user commands to the CPU 102 (e.g., freezing or saving a still image). The microphone 172 connected through audio processor module 170 can be used by the inspector to provide voice commands or to record observations during an inspection. These recordings can be played back on speaker 171. The audio processor module 170 is a further example of a processing system component that can be disposed in control handle 220.

Memory module 140, can be used by the CPU 102 for frame buffering and temporary data storage. Memory module 140 can also be used as a program memory for storage of programs executed by the CPU 102, using RAM 141 or ROM 142, or using externally connected memory 143. External storage devices can include flash drives in the form of thumb drives and memory cards, such as a CompactFlash memory card, portable hard disk drives or other recordable storage devices such as CDs, DVDs, or EPROM devices, that are connectible to CPU 102 over a USB port, for example. The memory module 140 can be used to save, recall, transmit, and/or receive still images, video, or audio. Software for operating borescope inspection apparatus 100 can be retained in CPU accessible RAM 141, ROM 142, or external storage 143.

Still or video images can be transmitted over network module 150 to IP network 203 and to computer terminals 201, 202 for the benefit of remote designated experts to view and analyze the transmitted video or still images. Borescope inspection apparatus 100 can be switched from a live streaming video mode in which a live streaming video is being displayed on local or remote display to a mode in which a selected still image is displayed. Borescope inspection apparatus 100 is configured so that an inspector can control video or still image output by actuating menu controls using key pad 161 or joystick 162, for example. Control signals can include freeze frame and save frame control signals. The borescope inspection apparatus 100 can be configured so that when a freeze frame control signal is initiated, it is saved in a memory of memory module 140. Borescope inspection apparatus 100 can be configured to store image data into predetermined file formats such as JPEG (Joint Photographic Experts Group), TIFF (Tagged Image File Format), PNG (Portable Network Graphics), or other file formats. Video files can be saved as MPEG (Motion Picture Experts Group), QuickTime, or other moving image file formats. CPU 102 can be configured to encode digital streaming video such as an MPEG formatted video. Borescope inspection apparatus 100 can be configured to initiate an IP based streaming video communication connection with computer terminals 201, 202, on an external private network 210 as shown in FIG. 2, and as explained below. When an IP based communication session has been established, data packets containing video data, e.g., MPEG packets, can be streamed over the connection.

The CPU 102 can also be in communication with local or remote external computers over network module 150 which provides various interfaces to peripheral devices and networks, such as wired networks connected over a wired network connection 151 such as USB port, Ethernet 10/100, and wireless networks connected over wireless network connection 152, such as a WiFi network 205, using internal transceiver antenna 153. Borescope processing station 101 can be configured to send frames of image data or streaming video data over these connections to an external server computer 204. The borescope processing station 101 can be programmed to incorporate a TCP/IP (Transmission Control Protocol/Internet Protocol) communication protocol for communicating with network connected computer terminals such as laptop 201 or workstation 202. The borescope inspection apparatus 100 can be compliant with several transport layer protocols including TCP, UDP (User Datagram Protocol), HTTP (Hypertext Transfer Protocol) and FTP (File Transfer Protocol), for example. Power supply module 130 provides power to the borescope processing station 101 as well as borescope processing station buses 103. Power supply module 130 can be connected to an AC source using AC power supply 131, or to an internal rechargeable DC power supply 132, or separately provided battery 133. Power supply module 130 supplies power to all the electronic components of processing station 101 and insertion tube 180.

An exemplary remote visual inspection system 200 is shown in FIG. 2. The remote visual inspection system 200 can include a plurality of network connected computer terminals such as laptop 201 or workstation 202 communicating with borescope inspection apparatus 100 over a public IP network 203, such as the internet, and private IP network 210 such as a private intranet. For example, remote visual inspection system 200 can include computers in the form of borescope inspection apparatus 100, laptop computer 201, workstation computer 202, server computer 204, and mobile computers in the form of tablet computer 206 or mobile telephone 207 connected to a WiFi network managed by server computer 204. Laptop 201 and workstation 202 computer terminals can be part of a private network 210 such as a local area network (LAN) or a private intranet in communication with the borescope inspection apparatus 100 over IP network 203. Private network 210 can be disposed apart from borescope inspection apparatus 100 up to thousands of miles. Tablet computers 206, in one embodiment, can communicate with borescope inspection apparatus 100 over wireless access points 205 in the private network 210 or after logging in to server computer 204 over IP network 203 after accessing IP network 203 using a wired or wireless access point therefor. Similarly, in one embodiment, mobile telephone 207 can communicate with borescope inspection apparatus 100 over wireless access points 205 in the private network 210 or after logging in to server computer 204 over IP network 203 after accessing IP network 203 using a wireless access point therefor.

Server computer 204 can be configured as a network management server and gateway server for managing private network 210 which, therefore, maintains a record correlating assigned IP addresses with device identifiers (e.g., lower layer addresses) for all devices operating on private network 210. Communications between internet connected computers such as borescope inspection apparatus 100 and computer terminals internal to private network 210 are established through permissions managed by server computer 204. Computers connected to private network 210 can support an IP protocol and can be configured to support a variety of transport layer protocols such TCP and UDP, and a variety of application layer protocols such at FTP and HTTP. Server computer 204 can be configured to enforce a firewall between internal computer terminals 201, 202 and IP network 203. Permitted users can access data and applications stored on computers within private network 210 by communicating with and logging onto server computer 204 using, for example, confidential access codes. Applications supported by server computer 204 within private network 210 can include email, texting, social communications, audio-visual communications, file system management for managing data belonging to users of private network 210, and various productivity applications, such as for employees utilizing network 210 as an intranet. Server computer 204 stores and accesses server computer storage 208 for executing network management software, applications operated by computer terminals 201, 202, and for storing, managing, and controlling access to network generated data.

The design of the remote visual inspection system 200 contemplates that there may be persons in spaced apart locations forming an inspection team interested in the results of an inspection being performed by an inspector using borescope inspection apparatus 100. In one embodiment, IP based video streaming communication can be carried out between borescope inspection apparatus 100 and a person situated at computer terminals 201, 202 remotely located with respect to the borescope inspection apparatus 100. In this embodiment, an inspector using borescope inspection apparatus 100 accesses server computer 204 over IP network 203 and transmits still or video images to server computer 204, for example to be stored therein in server computer storage 208. The stored image data can be accessed by persons situated at computer terminals 201, 202 who have permission to access image files stored on server computer 204. Similarly, persons can be situated externally to private network 210 and log in to server computer 204 before being permitted to access the stored image data. While live image data, such as video data, is being transmitted to server computer 204 from borescope inspection apparatus 100, a designated expert can log into server computer 204 using a computer terminal or other access device, and activate a link provided by server computer 204 causing server computer 204 to stream live video from the borescope inspection apparatus 100 to the access device of the designated expert.

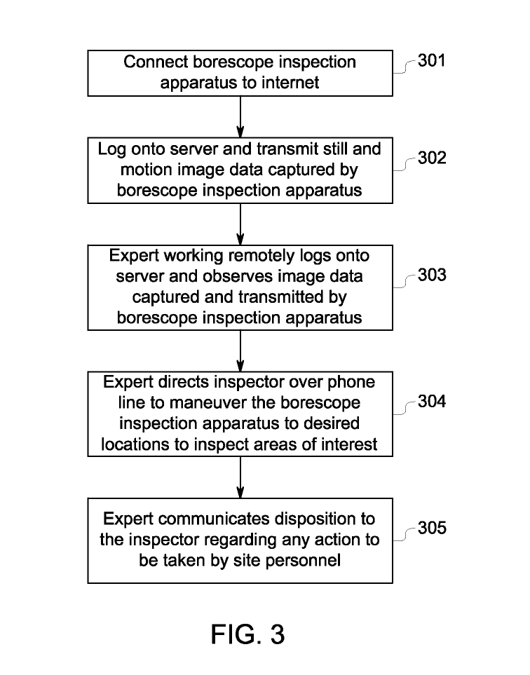

With respect to FIG. 3, there is illustrated a method of operating remote visual inspection system 200 as just described. At step 301 an inspector operating the borescope inspection apparatus 100 connects the borescope inspection apparatus 100 to public IP network 203, such as the internet, either through an Ethernet port or USB via wired network connection 151, or through Wi-Fi via internal transceiver antenna 153, either of which may require access service from an internet service provider. After connecting to network 203 and, for example, accessing a website established by server computer 204, at step 302 the inspector logs onto private server computer 204 and transmits borescope inspection apparatus 100 image output to the server computer 204 either in still image format or video for storage thereon or, if a designated expert simultaneously accesses server computer 204, then a live video stream can be established by forwarding the video feed from borescope inspection apparatus 100 to the designated expert's terminal. The image data as captured by the borescope camera head assembly 181, and transmitted over IP network 203 to server computer 204, can be also be simultaneously displayed on a control handle display screen 222 and observed by the inspector who is maneuvering insertion tube 180. At step 303, a designated expert working remotely logs in to private server computer 204 using an internet access device having a display screen, such as a laptop, workstation, tablet, or other hand held mobile device. The designated expert accesses the still or video images being output by borescope inspection apparatus 100 through, for example, a link provided by server computer 204. The still or video images captured by the inspector using borescope inspection apparatus 100 can be stored by server computer 204 in attached server computer storage 208, which can be accessed for later viewing by logging in to private sever 204. Alternatively, the designated expert can activate the link, provided by server computer 204, to video image data being transmitted to server computer 204 from borescope inspection apparatus 100 which causes server computer 204 to stream the video image data received from borescope inspection apparatus 100 to the designated expert's network device. At step 304 the inspector begins inspection under live direction of the designated expert over a live voice connection using, for example, a phone line. The designated expert can direct the inspector to maneuver the borescope inspection apparatus 100 to desired locations to inspect areas of interest that the designated expert can observe at his or her network connected terminal. At step 305, the designated expert communicates disposition to the onsite inspector regarding any actions to be performed by site personnel in response to information obtained during the inspection just undertaken.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a RAM, a ROM, an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A remote visual inspection system comprising:
a borescope inspection apparatus comprising an elongated tube having a distal end and a proximate end, the distal end comprising an image capture device and the proximate end connected to a processing station;
the processing station comprising a first network connection port for transmitting live digital video captured by the image capture device over the first network; and
a computer terminal having a display for receiving the live digital video transmitted over the first network.

2. The remote visual inspection system of claim 1, further comprising a server connected to the first network and to a second network, the server receiving the live digital video transmitted over the first network from the video borescope, wherein the computer terminal is connected to the second network and receives the live digital video transmitted over the second network from the server.

3. The remote visual inspection system of claim 2, further comprising a plurality of computer terminals each having a display for receiving the live digital video, wherein the plurality of computer terminals are each connected to the second network and each receive the live digital video transmitted over the second network from the server.

4. The remote visual inspection system of claim 2, wherein the second network comprises a WiFi access point and wherein the computer terminal is connected to the second network via the WiFi access point.

5. The remote visual inspection system of claim 2, wherein the server comprises server storage for storing the received live digital video in a Quicktime format or a Motion Picture Experts Group format.

6. The remote visual inspection system of claim 1, wherein the network connection port comprises a USB port, a wireless port, or an Ethernet port.

7. A remote visual inspection system comprising:
a borescope inspection apparatus comprising an elongated tube having a distal end and a proximate end, the distal end comprising an image capture device and the proximate end connected to a processing station;
the processing station comprising a display screen for displaying digital images captured by the image capture device and a first network connection port for transmitting live the digital images captured by the image capture device over the first network; and
a computer terminal having a display for receiving the live digital images transmitted over the first network.

8. The remote visual inspection system of claim 7, further comprising a server connected to the first network and to a second network, the server receiving the live digital images transmitted over the first network from the borescope inspection apparatus, wherein the computer terminal is connected to the second network and receives the live digital images transmitted over the second network from the server.

9. The remote visual inspection system of claim 8, wherein the display screen and the computer terminal display each display the same live digital images from the borescope inspection apparatus substantially simultaneously.

10. The remote visual inspection system of claim 8, further comprising a plurality of computer terminals each having a display for receiving the live digital images, wherein the plurality of computer terminals are each connected to the second network and each receive the live digital images transmitted over the second network from the server.

11. The remote visual inspection system of claim 8, wherein the second network comprises a WiFi access point and wherein the computer terminal is connected to the second network via the WiFi access point.

12. The remote visual inspection system of claim 8, wherein the server comprises server storage for storing the received live digital images in a Joint Photographic Experts Group format, a Tagged Image File format, a Portable Network Graphics format, a Quicktime format, or a Motion Picture Experts Group format.

13. The remote visual inspection system of claim 7, wherein the network connection port comprises a USB port, a wireless port, or an Ethernet port.

14. A method of remote visual inspection of an article of manufacture, the method comprising:
maneuvering an insertion tube of a borescope inspection apparatus into an interior region of an article, the insertion tube electrically connected to the borescope inspection apparatus;
connecting the borescope inspection apparatus to a first communication network;
capturing digital images of the interior region of the article using an image capture device in the insertion tube;
forwarding the captured digital images of the interior region of the article live over the first communication network; and
receiving the live forwarded captured digital images of the interior region of the article at a computer terminal, the computer terminal having a display screen for displaying the live forwarded captured digital images.

15. The method of claim 14, further comprising:
providing a server;
connecting the server to the first communication network and to a second communication network;
connecting the computer terminal to the second communication network;
receiving live at the server the captured digital images of the interior region of the article forwarded over the first communication network; and
forwarding the captured digital images of the interior region of the article live from the server over the second communication network to the computer terminal.

16. The method of claim 14, wherein the step of connecting the borescope inspection apparatus to a first communication network comprises using a USB port, a cellular network port, or an Ethernet port.

17. The method of claim 14, wherein the step of maneuvering the insertion tube comprises a designated expert directing an inspector to maneuver the insertion tube.

18. The method of claim 14, wherein the step of maneuvering the insertion tube comprises a designated expert communicating directions, over a phone line to an inspector listening over the phone line, for directing the inspector to maneuver the insertion tube to an area of the interior region of the article that is of interest to the designated expert.
